(19) United States
(12) Patent Application Publication
(10) Pub. No.: US 2025/0042673 A1
(43) Pub. Date: Feb. 6, 2025

(54) APPARATUS AND METHODS RELATING TO SORTING OBJECTS

(71) Applicant: KENNEDY TECHNOLOGIES LIMITED, Auckland (NZ)

(72) Inventors: Hamish Alexander Nigel KENNEDY, Auckland (NZ); Finn Marcus KENNEDY, Auckland (NZ); Andrew David MCINTYRE, Auckland (NZ)

(21) Appl. No.: 18/717,463

(22) PCT Filed: Dec. 12, 2022
(86) PCT No.: PCT/IB2022/062095

§ 371 Date: Jun. 7, 2024

(30) Foreign Application Priority Data
Dec. 10, 2021 (NZ) 783382

(51) Int. Cl. B65G 47/96; B65G 17/16; B65G 47/38

(52) U.S. Cl. CPC B65G 47/967; B65G 17/16; B65G 47/38

(57) ABSTRACT

Apparatus for sorting articles includes a conveyor having a plurality of article support members, each article support member provided to extend longitudinally parallel to a direction of movement of the conveyor, the support members being provided spaced 5 transversely across a conveyor and being pivotable at a first end about a transverse axis to unload the article from the conveyor.

The present invention relates to apparatus for sorting or grading objects or articles and in particular, but not solely, to fruit and/or vegetable carrying and tipping apparatus used in the grading and/or packaging of fruit and/or vegetables.

### BACKGROUND

Sorting and grading apparatus for fruit usually comprises an endless circuit of carriers on a conveyor chain. The carriers are situated to unload fruit at various stations appropriate to, for example, fruit weight, size, colour or defect type.

The carriers are typically sized and contoured depending upon the nature of the articles or objects which are being sorted or graded. Because there are a large variety of different sizes and shapes of fruit, sorting using carriers can be problematic. Fruit such as apples can be accommodated in relatively small and evenly shaped carriers. However, melons for example require a completely different form of carrier. Providing long conveyor lines, each with different carrier assemblies is expensive and cumbersome.

Weighing of the fruit is often required to be performed as fruit is being conveyed. The weight information can be used to make a determination as to the station at which the fruit should be unloaded. In existing systems, weighing requires that the fruit are separated, that is one per carrier and that the carrier is stable with minimal external forces. This can be difficult to achieve in high-speed sorting systems.

For the purpose of this specification, where method steps are described in sequence, the sequence does not necessarily mean that the steps are to be chronologically ordered in that sequence, unless there is no other logical manner of interpreting the sequence.

### Object

It is an object of this disclosure to provide an improved sorting or grading apparatus, system or method, or to at least provide a useful alternative to known apparatus, systems or methods.

### STATEMENTS OF INVENTION

In one aspect the invention broadly consist in an apparatus for sorting articles comprising a plurality of article support members arranged transversely across a conveyor, the support members being pivotable about a transverse axis to unload the article from the conveyor.

Each article support member may be provided to extend longitudinally parallel to a direction of movement of the conveyor, and being pivotable at a first end about the transverse axis to unload the article from the conveyor.

Each article support member may have a releasable latch at a second end opposite the first end. The latch my be self-latching.

Optionally, the support members are configured such that two support members support one article. Each support member may comprise a first part and a second part pivotably connected to the first part. The first part is configured to support an article and the second part is configured to allow the first part to be raised for weighing the article.

An arc limiting means may also be provided on at least one of the conveyor or the support member configured to limit an arc of movement of the support member about the transverse axis.

A loading means can be provided, being configured to receive an article, controllably decelerate the article and move the article onto one or more support members. The loading means may be configured to lower a receiver as the article moves into the receiver.

In another aspect a method of sorting articles is provided, the method comprising supporting an article on a plurality of article support members arranged transversely across a conveyor, and allowing at least one of the article support members to pivot about a transverse axis to unload an article from the conveyor.

Optionally, unlatching an end of the article support member can be effected to allow the article support member to pivot about an opposite end to unload the article.

In some embodiments the article is weighed and/or inspected prior to unloading.

The method may include limiting an arc of movement of the support member about the transverse axis.

The method may also include loading the article onto the conveyor by either controllably decelerating the article or lowering a receiver as the article moves onto the receiver, and moving the article onto one or more support members.

In another aspect a conveyor loading apparatus for loading articles onto a conveyor is provided, the apparatus comprising:
a receiver configured to receive an article;
a drive means configured to:
raise the receiver into a position for receiving an article to be loaded onto the conveyor;
lower the receiver as the article moves onto the receiver;
move the article onto a support surface of the conveyor.

Lowering the receiver can have the effect of controllably decelerate the article. Optionally, at least one guide member can be provided on one side of the receiver.

The drive means may comprise a mechanism configured to guide the receiver using a profile, for example a profile which is followed by the receiver or a part thereof.

In another aspect a method for loading an article onto a conveyor is provided, the method comprising:
controllably decelerating the article and moving the article onto one or more support members of the conveyor.

The method may additionally or alternatively include raising a receiver into a position for receiving an article to be loaded onto the conveyor, and lowering the receiver as the article moves onto the receiver.

In another aspect a conveyor article grading apparatus is provided comprising
a plurality of article support members disposed side-by-side across the conveyor,
each article support member having an axis extending parallel to the direction of movement of the conveyor, a first mounting means and a second mounting means separated along the axis from the first mounting means,
the first mounting means pivotably connecting the article support member to the conveyor, and the second mounting means releasably connecting the article support member to the conveyor, whereby the second mounting means is configured to allow the support member to pivot about the first mounting means to unload an object from the conveyor.

In another aspect an article support for a conveyor article grading apparatus is provided, the article support comprising
an axis extending parallel to the direction of movement of the conveyor,
a first mounting means and a second mounting means separated along the axis,
the first mounting means pivotably connecting the article support member to the conveyor, and the second mounting means releasably connecting the article support member to the conveyor, whereby the second mounting means is configured to allow the support member to pivot about the first mounting means to unload an object from the conveyor.

In an embodiment the article support comprises an article support surface. The article support surface may be provided between, or above and between the first and second mounting means.

In an embodiment the second mounting means follows the first mounting means the direction of movement of the conveyor.

In an embodiment the second mounting means includes a latch which is operable to release the support member.

In an embodiment the conveyor comprises a plurality of transverse carrier elements. The first mounting means engages with a first carrier element and the second mounting means engages with a second carrier element. The first and second carrier elements can carry a plurality of article support members.

In an embodiment the first mounting means of an additional article support member is engaged with the second carrier element.

In an embodiment the article support surface is contoured. The contour may be such that a region of the article support surface in the vicinity of one or both of the mounting means is higher than a region of the article support surface between the mounting means. The article support surface may comprise a curve, or a V shape or a U shape.

In some embodiments the second mounting means of one article support member is released to unload an object supported by a plurality of article support members.

In some embodiments the second mounting means of a plurality of article support members are released to unload an object supported by the plurality of article support members.

In some embodiments releasing the second mounting means allows the article support member to pivot under gravity about the first mounting means to unload an article from the conveyor.

In some embodiments the latch comprises a latch member provided on the support member. In other embodiments the latch comprises a latch member provided on the carrier element.

In some embodiments the latch member comprises a hook pivotally mounted to the support member. The hook is configured to engage with a carrier element of the conveyor.

In some embodiments the latch comprises a first trigger which is configured to release the hook from the carrier element of the conveyor.

In some embodiments the latch comprises a second trigger which is configured to engage the hook with the carrier element of the conveyor.

In some embodiments each trigger is configured such that a force applied to the trigger rotates the hook about its pivotal mounting to thereby release or engage the hook to or from the carrier element.

In some embodiments the article support member is configured to be selectively supported independently of the mounting means to facilitate weighing an object carried by the support member. In some embodiments the first mounting means is pivotably connected to the article support member. This allows the second mounting means to be released such that the article support member can be supported independently of the first and second mounting means to facilitate weighing an object.

In another aspect the invention broadly consists in a method of sorting articles, the method comprising supporting an article on a plurality of article support members arranged transversely across a conveyor, and allowing at least one of the article support members to pivot about a transverse axis to unload the article from the conveyor.

The method may include releasing a mounting means of the article support member to allow the article support member to pivot.

The method may include allowing the article support member to pivot under gravity.

The method may include, determining a location for unloading the article, determining when the article support members of the conveyor are located adjacent to the location, and activating the one or more article support members to unload the article at the location.

The method may include detecting a property of the article and determining the location for unloading the article dependent upon the detected property.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification and claims means “consisting at least in part of”. When interpreting statements in this specification and claims which include that term, the features, prefaced by that term in each statement, all need to be present but other features can also be present. Related terms such as “comprise” and “comprised” are to be interpreted in the same manner.

The entire disclosures of all applications, patents and publications, cited above and below, if any, are hereby incorporated by reference.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE FIGURES

The invention will now be described by way of example only and with reference to the drawings in which:

FIG. 1: shows a perspective view of a part of a conveyor;

FIG. 2: shows a plan view of FIG. 1;

FIG. 3: shows an end elevation of FIG. 2;

FIG. 4: shows a side elevation of FIG. 2;

FIG. 5: shows an expanded view of detail A of FIG. 2;

FIG. 6: shows a perspective view of an article support member;

FIG. 7: shows a side elevation of FIG. 6 with the article support member supporting an object;

FIG. 8: shows an exploded view of FIG. 6;

FIG. 9: shows a side elevation of FIG. 8;

FIGS. 10-12: show side elevations of FIG. 6 in which a support means of the article support member is released from a carrier element of the conveyor and subsequently re-engaged therewith;

FIG. 13: shows a side elevation of FIG. 6 in which the article support member is disposed in orientation configured for weighing an object supported thereby;

FIG. 14: shows an exploded isometric view of another example of an article support member;

FIGS. 15 and 16: show partial isometric views of the article support member of FIGS. 14;

FIGS. 17 and 18: show partial isometric views of a conveyor loading or transfer apparatus;

FIGS. 19-24: show partial side elevations with detail removed to illustrate a sequence of operation of conveyor loading apparatus.

### DETAILED DESCRIPTION

With reference to the accompanying drawings, in which like features are generally indicated by like reference numerals, examples of an article sorting or grating apparatus, system and method according to at least one aspect of the present disclosure is described.

Although the invention has been described by way of example and with reference to particular embodiments, it is to be understood that modifications and/or improvements may be made without departing from the scope or spirit of the invention.

Preferably the processes herein described are at least partially, or fully automated.

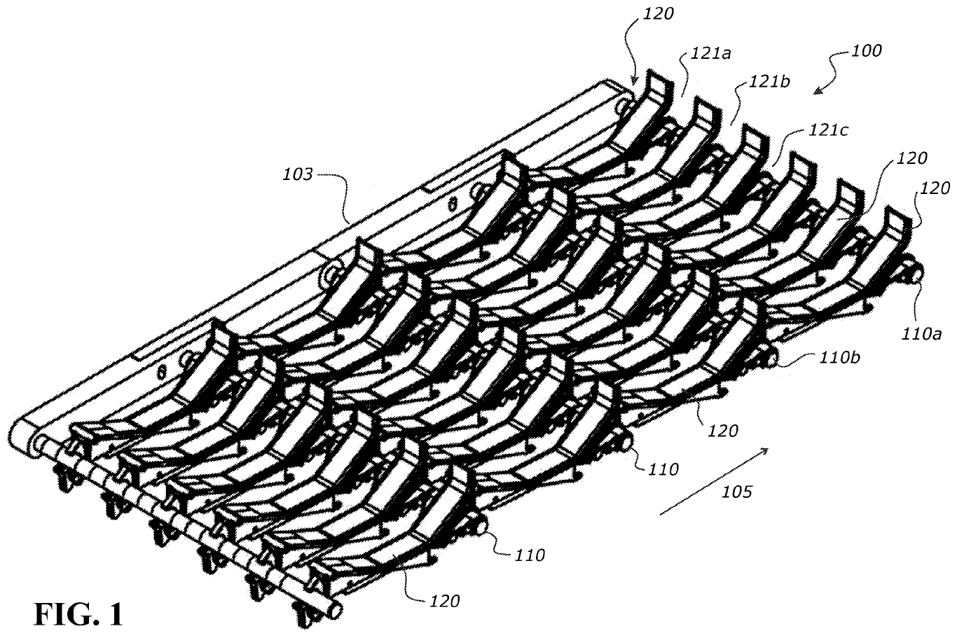

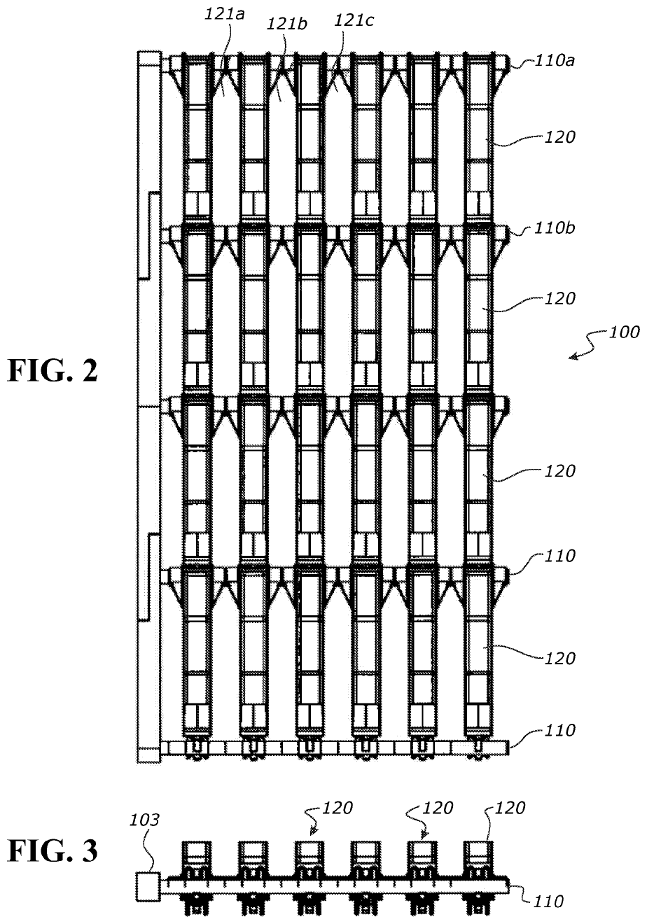

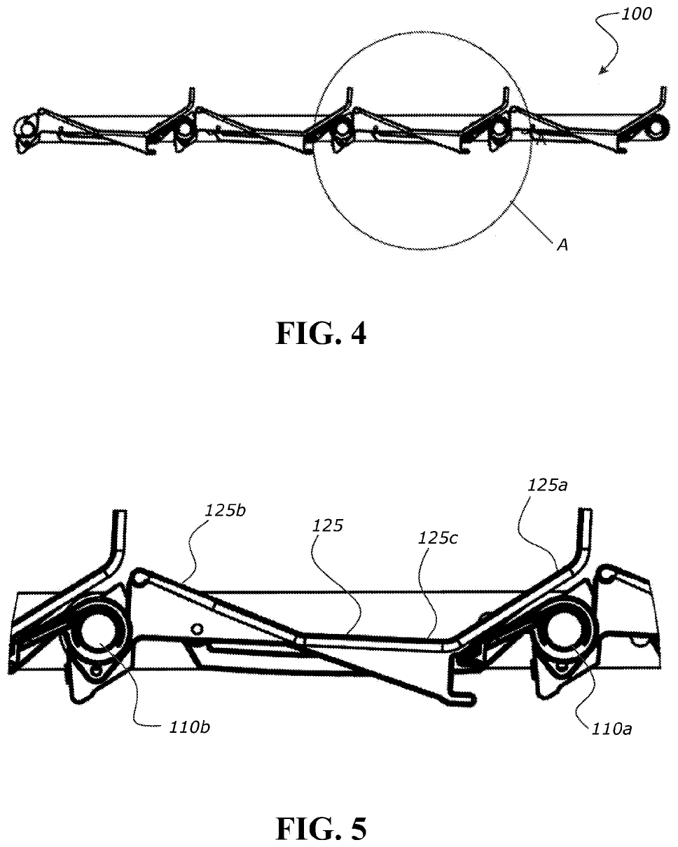

Turning to FIGS. 1 to 5, FIG. 1 shows one exemplary section or part of an endless conveyor generally referenced 100. Although only one part of the conveyor is shown for purposes of ease of illustration, those skilled in the art will understand that the conveyor is arranged in a loop and is therefore essentially endless, extending in both directions illustrated by arrows 102 and 104. The direction of travel of the conveyor in use in this example is in the direction shown by arrow 105. The edge 103 of the conveyor is shown for illustrative purposes and will typically not take the form shown in the drawings. In many embodiments the conveyor will have at least one and usually two side edges (one at each side of the conveyor) each of which is in the form of a chain. The chain or chains will support carrier elements as described below and ensure that those elements remain spaced apart at the distance required for the support members that are engaged with the carrier elements.

The conveyor 100 comprises a plurality of carrier elements 110, which in the example illustrated comprise rods, but may be provided in other formations. The carrier elements 110 generally extend transversely across the conveyor i.e. transverse to the direction of movement of the conveyor 105. Article support members 120 are engaged with adjacent pairs (for example 110a and 110b) of carrier elements. Article support members 120 arrange side-by-side. That is to say article support members 120 are arranged transversely across the conveyor 100. In some embodiments at least 2 support members 120 arrange side-by-side between each pair of carrier elements 110. However, any number of support members 120 may be provided side-by-side extending transversely across the conveyor. The number and spacing of support members that are provided will depend upon the objects or articles that the conveyor is transporting. For example, if relatively small articles are being carried, then the support members may be closely spaced together, and may themselves be relatively narrow in width. Conversely, if large articles are being carried, then the support members 120 may be spaced further apart, and may optionally have a wider upper surface which supports the article. An example of an article which is relatively large may be a melon for example.

As shown in FIG. 5, each article support member may include a support surface 125. The support service 125 can be provided in any required contour. In this example, the contour which is provided as end regions 125a and 125b which extend above the central region 125c located between the end regions. Therefore, the surface 125 can be provided in a V shape or U shape or variations thereof configured to assist with one or more of receiving, containing and unloading articles such as fruit.

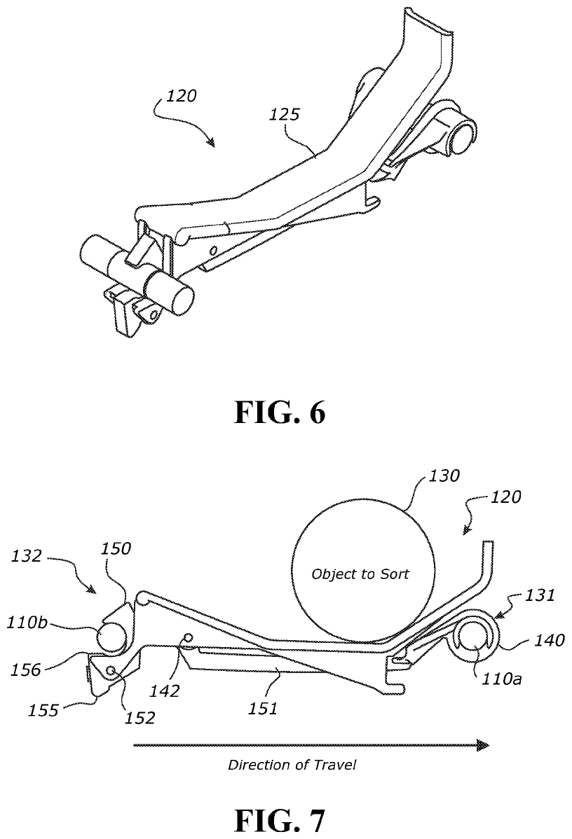

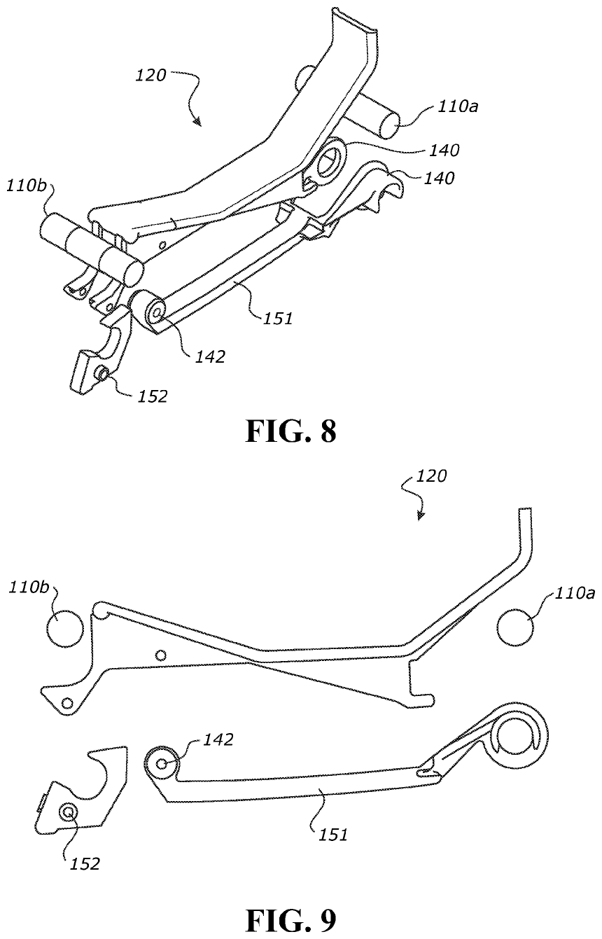

FIGS. 6 to 9 show the article support member 120 more clearly, and in FIG. 7 an object 130 such as piece of fruit as shown being carried by the support member apparatus. As can be seen in FIGS. 6 and 7, the support member 120 has a first mounting means or end 131 for engagement with the first carrier element 110a, and a second mounting means or end 132 for engagement with the second carrier element 110b. The first mounting means 131 comprises one or more mounting sleeves 140 which are engaged with the carrier element 110a to provide a pivotal connection which allows the support member 120 to pivot about the carrier element 110a as will be described further below. In some embodiments, such as the embodiment illustrated, the first mounting means can extend forming a second portion 151 of the article support member that can be pivotally connected to the support member 120 as shown by pivot connection 142. Those skilled in the art will appreciate that pivot connection 142 is not essential.

The second mounting means 132 includes a latch assembly which comprises a latch member in the form of hook member 150 that is pivotably connected to the support member that pivot connection 152. Two trigger elements are provided for of the hook member 150. A first trigger element 155 is configured such that a force applied to the trigger element 155 moves hook 150 to unlatch the second mounting means. A second trigger element 156 is configured such that a forced applied to the trigger 156 moves the hook 150 to latch the second mounting means with the carrier element 110b. Operation of the latch is described further below.

It will be seen by those skilled in the art that a latch means such as a latch or hook member for example may be provided on or as part of the carrier element 110b rather than on the support member 120. Therefore, the second mounting means may be configured to releasably engage or latch via a latch member provided on the carrier element.

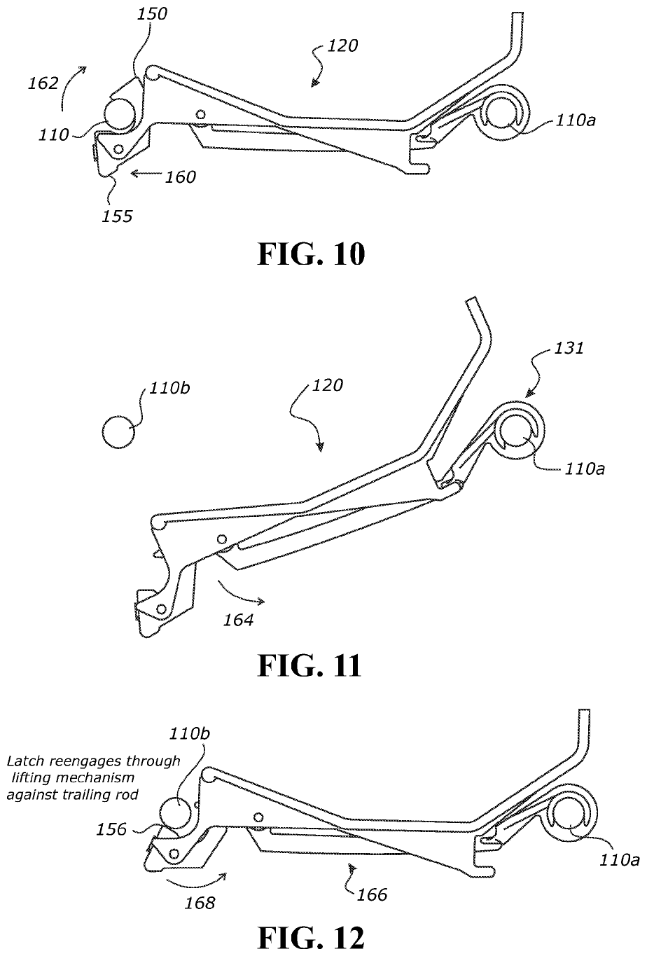

Referring to FIGS. 10 to 12, when an object supported by the apparatus as required to be unloaded, the second mounting means can be unlatched to allow support member 120 to pivot about the first mounting means 131 and thereby allow the apparatus to rotate under gravity to release the object which is being supported so that it may be delivered to a required location. In some examples, a property of the article or object such as its mass can be detected, and when the article reaches a location at which it is required to be unloaded dependent on the detected weight, the support member can be operated to allow it to rotate to thereby allow the article to move under gravity so that it is delivered from the conveyor to the required location. In some examples the location may comprise a bin for collecting articles in a required weight range. In another example, a property of the article which is required to be detected may comprise a property relating to appearance, such as the shape of the article or a blemish or imperfection. This may be detected using a machine vision apparatus is known in the art to which the invention relates. Again, if the property is detected, then the article can be unloaded from the conveyor at a location dependent upon the detected property. As described above, and article may be supported by at least two support members 120, and in some embodiments only 1 of the support members needs to be released to allow the supported article to be unloaded from the conveyor. In some embodiments both the support members 120 (or more than two support members if the article is being carried by more than two support members) may be released to unload the article they are supporting.

In FIG. 10, the latching (and therefore unloading) process commences with a force being applied to trigger 155 as shown by arrow 160. This causes hook 150 to rotate as shown by arrow 162. Referring to FIG. 11, with hook 150 having been rotated, the second mounting means is released from carrier element 110b, so the support member 120 rotates under the influence of gravity about the first mounting means 131, as shown by arrow 164.

In FIG. 12, the support member 120 is lifted, being rotated about first mounting means 131 in an upward direction as shown by arrow 166. This will cause trigger 156 to contact carrier element 110 be as shown in FIG. 12, which applies a force to rotate the hook 150 about its pivot, causing the hook to rotate as shown by arrow 168 so that the support member 120 returns to the latched state as shown in FIG. 10.

Those skilled in the art will understand that the force which is applied to trigger 155 can be provided in a variety of different ways. Typically, an automated lever can be activated at the location beneath the conveyor in order to contact trigger 155 to apply the required force at the required time. Similarly, the support member 120 can be returned to the latched state by an automated lever which applies a force to directly support member 120 upwardly, rotating it about the first mounting means 131 until the second trigger 156 contacts carrier element 110b.

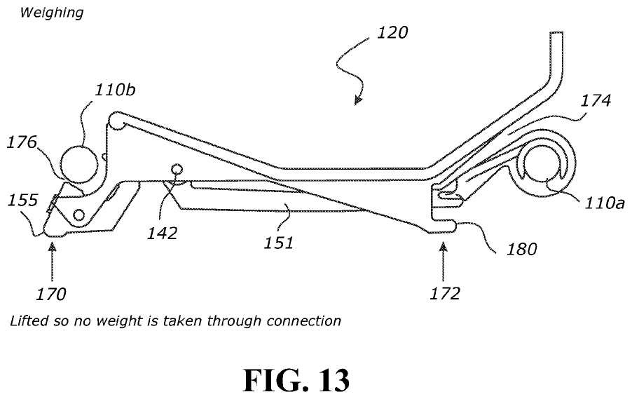

Referring to FIG. 13, it will be seen that the support member 120 can be disposed in a position which facilitates weighing an article carried by the support member. In use, according to one embodiment, the support member 120 is moved by the conveyor over a weigh scale which contacts trigger 155 and contact region 180. The support member 120 is configured such that upon the way scale contacting trigger 155 and contact region 180, the hook 150 is released from carrier element 110b, and the support member pivots about pivot 142 so that there is essentially no load being carried by carrier element 110a. Accordingly, the weigh scale can detect the mass of the article being supported by the apparatus, based on the known mass of the parts of the support element 120 which are directly supported by the weigh scale.

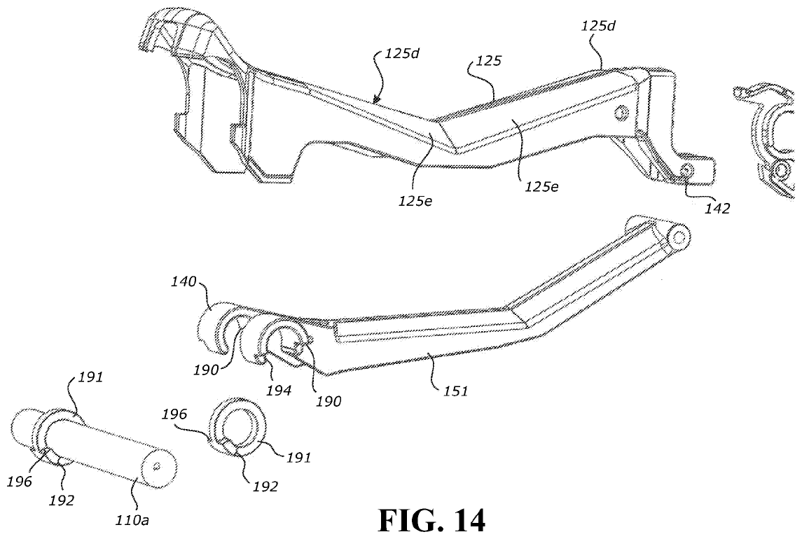

Turning now to FIGS. 14-16, another example of an article support member 120 is shown, which has a support surface 125 that is contoured slightly differently to that shown in the preceding Figures. In a manner which is similar to the example above, the article support surface 125 in this example has a depression in a region between the ends 131 and 132 i.e. it is V shaped or is concave when viewed from above. However, surface 125 in this example also comprises contoured side surfaces 125d and 125e which slope from the centre toward either side edge of the carrier 120. It will be seen that when two article carriers are placed side by side in a spaced relationship the support surfaces 125 will form a cradle therebetween. Thus, surfaces 125d of one carrier 120, and surfaces 125e of the adjacent carrier 120 together ramp or angle toward a central region between the carriers 120 to help locate and carry an article which is placed on them.

FIGS. 14-16 also illustrate another feature of the article carrier 120 which may be used with forms or the article carrier 120 other than that shown in FIGS. 14-16. As described above, each carrier 120 is configured to be selectively released at end 132 so that it may pivot at or about end 131 to discharge or unload the article 130 that it is carrying or supporting. Once released, the carrier 120 swings downwardly so that it describes an arc. In use, the arc through which the carrier 120 travels needs to be limited in order to prevent the free, unlatched, end of the carrier 120 from swinging to an extent that it interferes with adjacent carriers 120 or other nearby apparatus. Arc limiting means are therefore provided, being configured to limit the extent of the arc through which the article support may travel once release has occurred. In the example shown in FIGS. 14-16 the arc limiting means takes the form of a stop face or abutment 190 that comes into contact with a similar face or abutment 192 provided on the carrier element 110a. In this example, the face 192 is provided on a ring 191 that is mounted on element 110a so that it cannot rotate relative to carrier 110a. However, in other examples the element 110a may itself be integrally formed, or otherwise provided, with a contour against which face 190 can contact when the prescribed arc limit (for example approximately 90 to 100 degrees) has been reached so that further rotation of the article carrier 120 is prevented. A further stop face or abutment 194 can be provided to limit the arc of movement in the opposite direction i.e. to prevent the distal end 132 of the carrier 120 from moving too far upward, for example during the latching process.

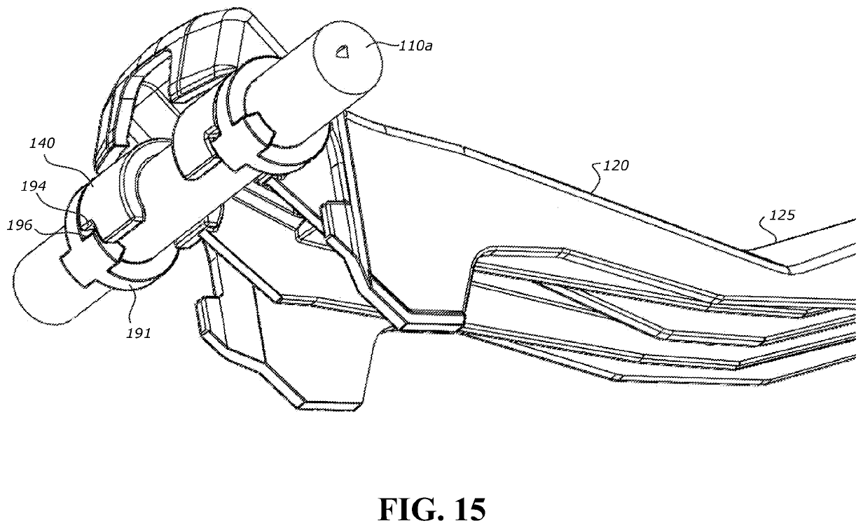

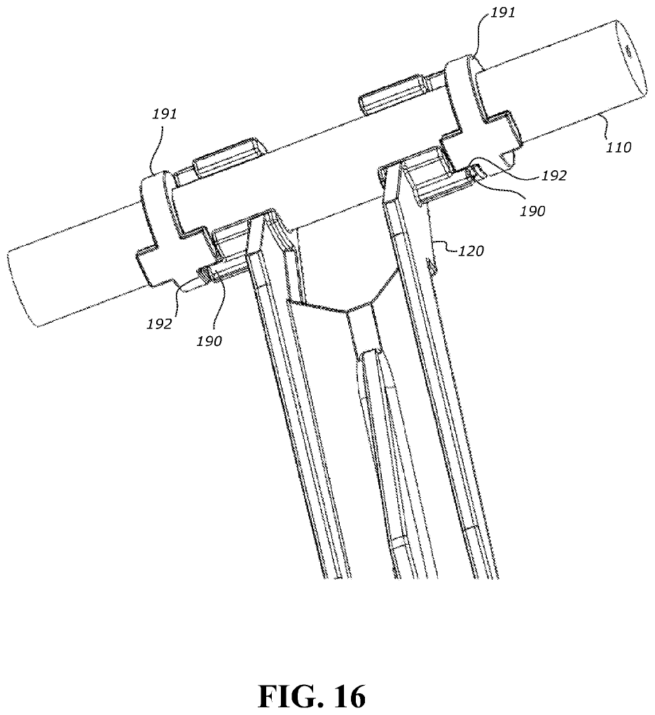

FIG. 15 shows the carrier 120 in the latched or near-latched state with faces 194 and 194 located proximate to each other. FIG. 16 shows the carrier 120 in the unlatched state, having swung through the prescribed arc, with faces 190 and 192 located proximate to each other, having made contact to arrest the progressive arcuate motion of carrier 120 during the unloading process.

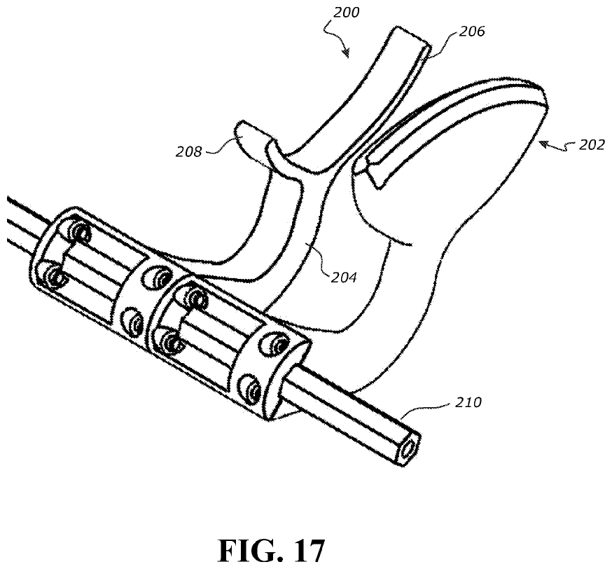

Referring now to FIGS. 17-24, a conveyor transfer or loading apparatus is illustrated which enables articles 130 to be transferred from another conveyor, such as conveyer 220, on to apparatus 100. A difficulty with transfer of articles onto a conveyer is ensuring that the article is introduced in such a manner that it does not roll or bounce off the conveyor it is being loaded onto. This problem is exacerbated at speed. In the present example, the articles 130 are introduced to conveyor 100 under gravity by falling from the end of conveyor 220 onto the end of conveyor 100.

The transfer apparatus shown in FIGS. 17-24 is configured to “catch” the article by lowering a receiver as the article is dropped or projected onto the receiver. Therefore, the apparatus provides a controlled deceleration of the article as it descends onto conveyor 100. The deceleration is primarily in the vertical direction, but may be configured as desired, for example in other directions or components.

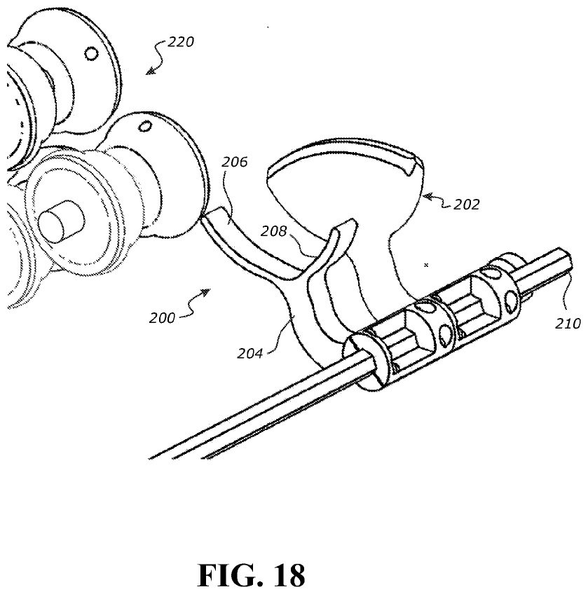

Shown in FIGS. 17 and 18, is an article receiver 200 which has a body 204 that is engaged at one end with a shaft 210. The other end of body 204 has extended arms 206 and 208 which are configured to receive an article 130. It will be understood that the shape and dimension of receiver 200 may change or vary dependent upon the shape, dimensions and mass of the article 130 that is to be received. Optionally, the receiver may have one or more co-operating guide members 202 which are configured to prevent an article 130 that is present in arms 206 and 208 from falling to one side or the other of the receiver 200. Thus members 202 may act or function as side walls form the receiver 200. Members 200 can also act as lane dividers, to keep articles 130 in separate lanes on conveyor 100. Each receiver 200 or guide 202 is configured to extend and retract cyclically from the space 121 between adjacent article carriers 120. In an example, there may be a receiver 200 in one space 121b between two carriers 120, then a guide 202 in space 121a on a first side of receiver 200 and another guide 202 in space 121c on the second side of receiver 200. There may be multiple receivers 200 and guides 202 or multiple sets of receivers 200 and guides 202 for a given conveyor installation, and the receivers and/or guides can extend across the conveyor 100 to define lanes into which articles are received onto conveyor 100.

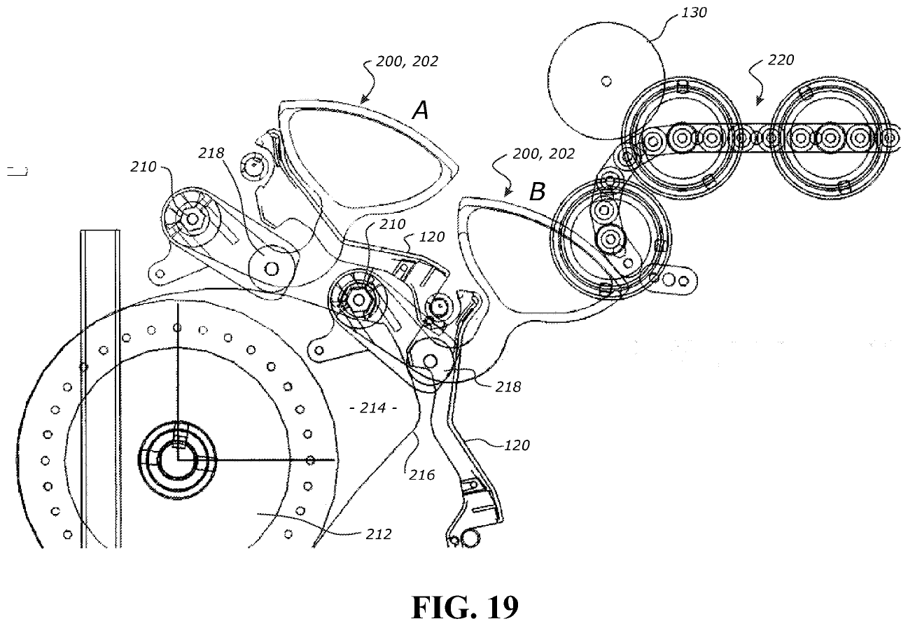

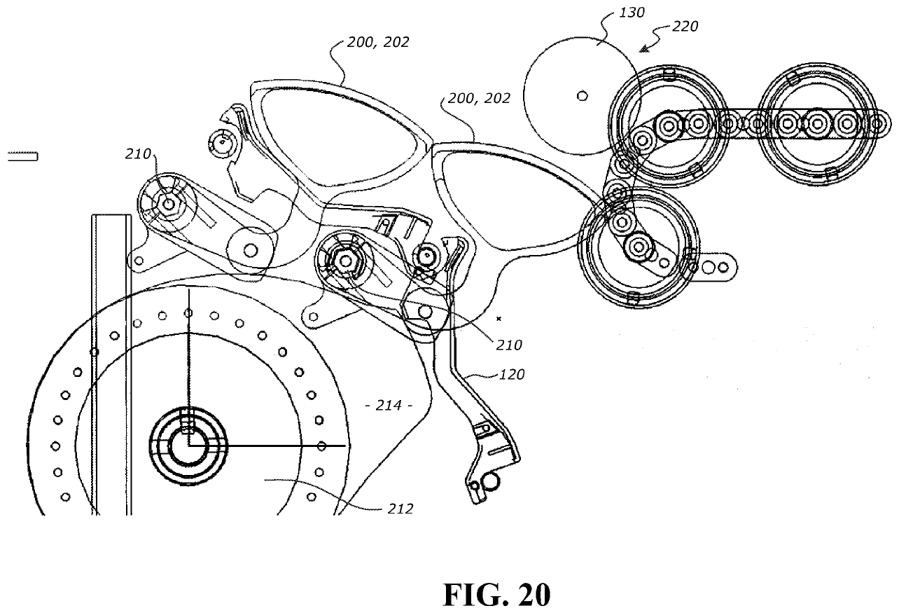

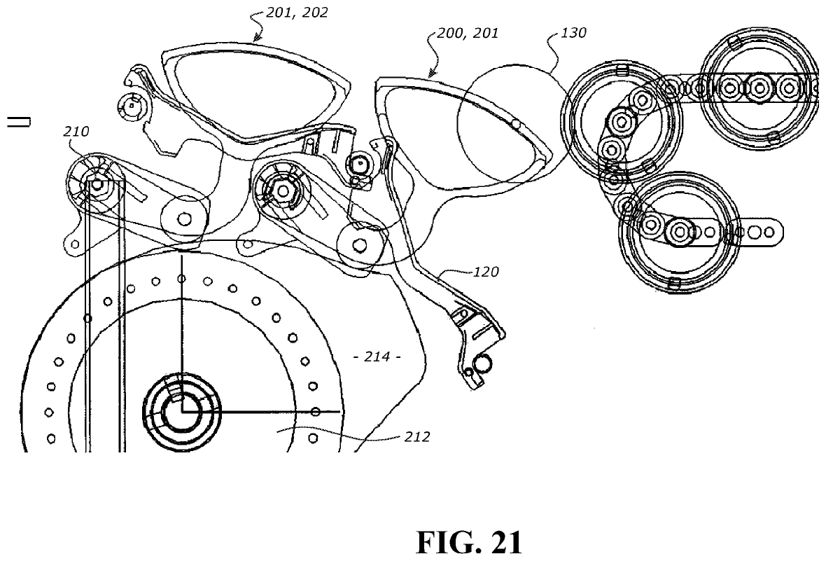

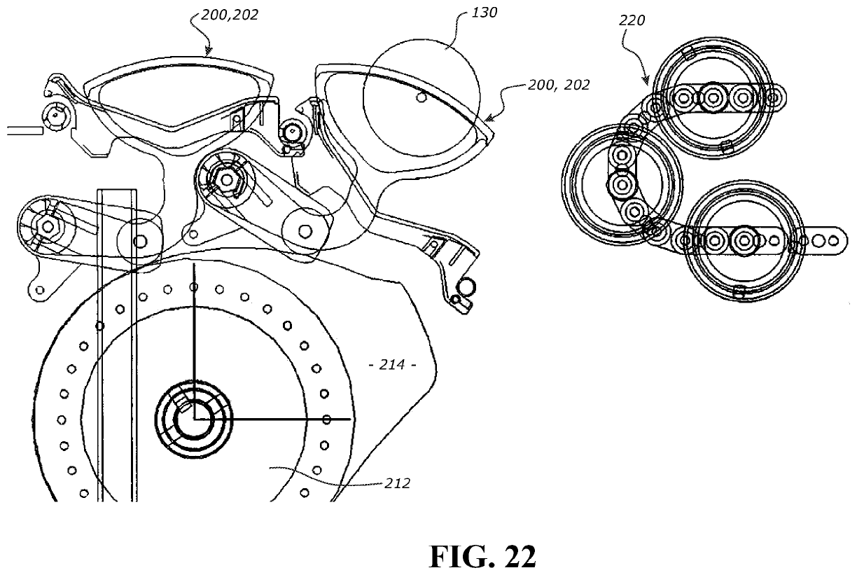

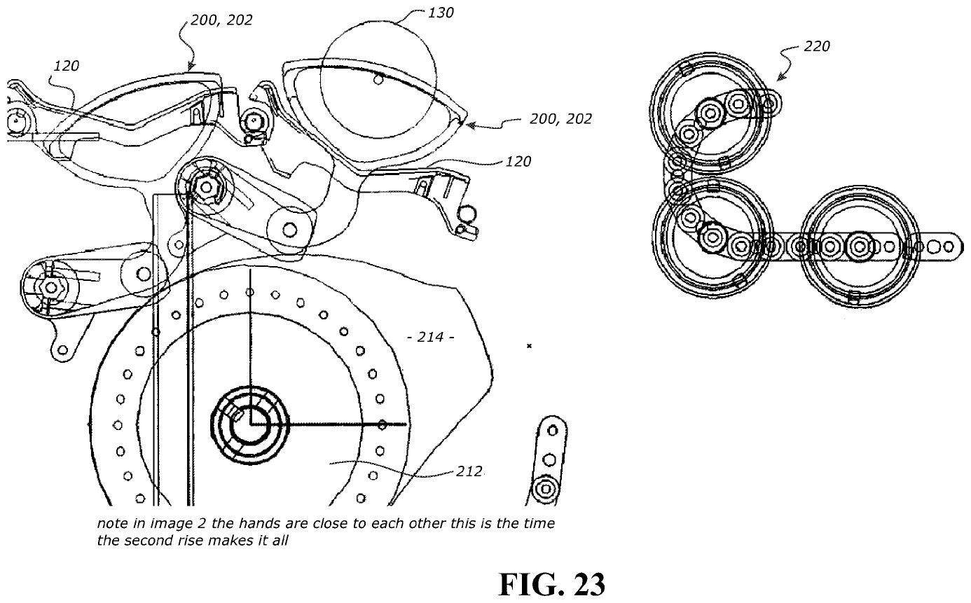

Referring now to FIGS. 19-24, a receiving sequence is illustrated as the receivers/guides 200/202 receive an article 130. A sprocket 212 is rotatably mounted to drive or facilitate operation of the conveyor 100, and only two carriers 120 are shown for clarity being rotated upwardly into an orientation in which they may receive articles 130 from feed conveyor 220. Two receivers 200 and/or guides 202 are shown, again for clarity purposes, arranged to rotate around the sprocket 214. The receivers/guides 200/202 may in this example pivot about shaft 210 in response to cam followers 218 which follow surface 216 of stationary cam 214 which causes the receivers/guides 200/202 to move in a defined path which includes protruding or rising to extend to a position to receive article 130 (refer FIGS. 19 and 20), then move lower to “catch” the article 130 (refer FIG. 21) by allowing the article 130 to decelerate and thereby absorb some kinetic energy from the article in at least the vertical direction and thus prevent the article from bouncing out of the receiver. The receiver 200 then rises slightly again as shown in FIGS. 22 and 23 to provide clearance for the following receiver.

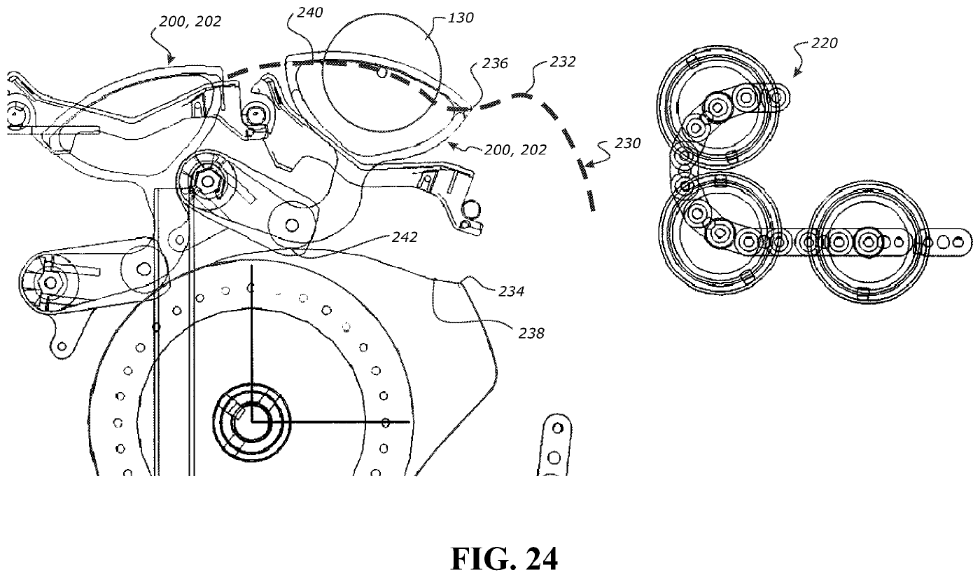

The action of the receivers/guides is shown in FIG. 24 by locus 230 (heavy broken line) that tracks the movement of one receiver/guide 200/202. The action, described with reference to a receiver 200, begins with the receiver being raised to point 232 (corresponding to 234 on the cam profile surface), then dips at 236 (238 on the cam profile) to catch the item by lowering in order to allow it to decelerate in a controlled manner and thus seat itself securely in the receiver 200. Then the receiver raises at 240 (242 on the cam profile) to extend clear from the following receiver and to bring the article 130 into the position required for transfer onto surface 125 of the carrier 120, before lowering (following on from region 240) or dropping into the space between adjacent carriers 120 to move or leave the article 130 supported by the carriers 120.

It will be understood that the loading or transfer apparatus described above can be used with conveyors other than conveyor 100 and is therefore not limited for use with conveyor 100.

It will be seen from the foregoing that the conveyor apparatus, sorting system and method is provided which can be expanded or reduced as required by adding or removing article support members 120 to or from the conveyor assembly to accommodate articles, such as fruit or vegetables, of a large variety of different sizes and shapes to be sorted or graded.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

As used herein the term “and/or” means “and” or “or”, both. As used herein “(s)” following a noun means the plural and/or singular forms of the noun. The term “comprising” as used in this specification means “consisting at least in part of”. When interpreting statements in this specification which include that term, the features prefaced by that term in each statement all need to be present, but the other features can also be present. Related terms such as “comprise” and “comprised” are to be interpreted in the same matter. The entire disclosures of all applications, patents and publications, cited above and below, if any, are hereby incorporated by reference.

1. An apparatus for sorting articles comprising:
a conveyor having a plurality of article support members, each article support member provided to extend longitudinally parallel to a direction of movement of the conveyor, the support members being provided spaced transversely across a conveyor and being pivotable at a first end about a transverse axis to unload the article from the conveyor.

2. The apparatus of claim 1 wherein each article support member has a releasable latch at a second end opposite the first end.

3. The apparatus of claim 2 wherein the latch is self-latching.

3. The apparatus of claim 1 or claim 2 wherein the support members are configured such that two support members support one article.

4. The apparatus of any one of the preceding claims wherein each support member comprises a first part and a second part pivotably connected to the first part.

5. The apparatus of claim 4 wherein the first part is configured to support an article and the second part is configured to allow the first part to be raised for weighing the article.

6. The apparatus of any one of the preceding claims further comprising arc limiting means provided on at least one of the conveyor or the support member configured to limit an arc of movement of the support member about the transverse axis.

7. The apparatus of any one of the preceding claims further comprising a loading means configured to receive an article, controllably decelerate the article and move the article onto one or more support members.

8. The apparatus of claim 7 wherein controllably decelerating the article comprises lowering a receiver as the article moves into the receiver to thereby controllably decelerate the article.

9. A method of sorting articles, the method comprising supporting an article on a plurality of article support members arranged transversely across a conveyor, and allowing at least one of the article support members to pivot about a transverse axis to unload an article from the conveyor.

10. The method of claim 9 further comprising unlatching an end of the article support member to allow the article support member to pivot about an opposite end to unload the article.

11. The method of claim 9 or claim 10 further comprising weighing the article prior to unloading.

12. The method of any one of claims 9 to 11 further comprising limiting an arc of movement of the support member about the transverse axis.

13. The method of any one of claims 9 to 12 further comprising loading the article onto the conveyor by controllably decelerating the article and moving the article onto one or more support members.

14. The method as claimed in claim 17 wherein controllably decelerating comprises lowering a receiver as the article moves into the receiver to thereby controllably decelerate the article.

15. A conveyor loading apparatus for loading articles onto a conveyor, the apparatus comprising:
a receiver configured to receive an article;
a drive means configured to:
raise the receiver into a position for receiving an article to be loaded onto the conveyor;
lower the receiver as the article moves onto the receiver to thereby controllably decelerate the article;
move the article onto a support surface of the conveyor.

16. The conveyor loading apparatus of claim 15 further comprising at least one guide member provided on one side of the receiver.

17. The conveyor loading apparatus of claim 15 or claim 16 wherein the conveyor loading apparatus is provided at an end on the conveyor.

18. The conveyor loading apparatus of anyone of claims 15 to 17 wherein the drive means comprises a mechanism configured to guide the receiver using a profile.

19. A method for loading an article onto a conveyor, the method comprising:
controllably decelerating the article and moving the article onto one or more support members of the conveyor.

20. The method of claim 19 further comprising raising a receiver into a position for receiving an article to be loaded onto the conveyor, and lowering the receiver as the article moves onto the receiver to thereby controllably decelerate the article.

21. A conveyor or sorter apparatus substantially as herein described.

22. A method of sorting or a method of loading a conveyor substantially as herein described.
